(19) United States
(12) Patent Application Publication
(10) Pub. No.: US 2016/0025285 A1
(43) Pub. Date: Jan. 28, 2016

(54) IMPROVED DOWNLIGHTS

(71) Applicant: AURORA LIMITED, St Albans Hertfordshire (GB)

(72) Inventor: Andrew Johnson, St Albans (GB)

(73) Assignee: Aurora Limited, St. Albans (GB)

(21) Appl. No.: 14/773,376

(22) PCT Filed: Mar. 6, 2013
(86) PCT No.: PCT/GB2013/050544

§ 371 Date: Sep. 7, 2015

(51) Int. Cl. F21S 8/02; F21V 5/04; F21V 23/02; F21V 29/70; F21V 29/15

(52) U.S. Cl. CPC F21S 8/026; F21V 29/70; F21V 29/15; F21V 23/02; F21V 5/04; F21Y 2101/02

(57) ABSTRACT

Improved lighting units are disclosed comprising a casing (14, 114) and a heat sink (11, 110) mounted to the casing (14, 114), a light source (6, 106) mounted to a front side of a circuit board (8, 108), the circuit board (8, 108) including control circuitry for the light source (6, 106), the heat sink (10, 110) provided in thermal contact with a rear side of the circuit board (8, 108) and a lens arrangement (12) located at the front side of the circuit board (8, 108), the circuit board (8, 108) and the light source (6, 106) being located in the casing (14, 114) wherein the circuit board (8, 108) comprises a ceramic circuit board, the arrangement being such that heat generated in use by the light source (6, 106) and control circuitry is transferred by conduction through the circuit board (8, 108) to the rear side of the circuit board (8, 108) and into the heat sink (10, 110).

### FIELD OF THE INVENTION

The present invention relates to an improved lighting unit, in particular, an improved construction of downlight utilising an LED light source

### BACKGROUND OF THE INVENTION

Downlight fittings or downlighters are a form of lighting unit becoming more and more widely used as light sources in domestic and commercial environments. They are particularly neat and unobtrusive in their appearance, since almost the entire downlight fitting is concealed behind a ceiling or other suitable panel or surface, whilst giving out a pleasing light. However, downlights suffer from a number of disadvantages.

Downlights generate significant amounts of heat. It is important to prevent overheating of the lighting element, and associated control circuit, since overheating will have obvious effects on the light output and service life of these components. Indeed, excessive temperatures will cause electronic components to fail leading to premature failure of the lighting unit. To this end it is known to provide LED lighting units with cooling means in the form of in the form of a heat sink or cooling fan to draw heat away from the lighting element to the rear of the lighting unit where ventilation openings are provided. In the case of fire rated downlights, the lighting unit will act as a fire barrier and the ventilation openings will be adapted to be closed in the event of fire, for example due to the expansion of intumescent material.

Known arrangements of lighting unit suffer inefficiencies in transfer of heat to the heat sink. It is an advantage of the present invention in that it provides a lighting unit having improved efficiencies in the transfer of heat to the heat sink.

### SUMMARY OF THE INVENTION

According to the present invention a lighting unit for mounting in an aperture comprises a casing and a heat sink mounted to one side of the casing, a light source mounted on a front side of a circuit board, the circuit board including control circuitry for the light source, the heat sink provided in thermal contact with a rear side of the circuit board and a lens arrangement located to the front side of the circuit board, the circuit board and the light source being located in the casing, wherein the circuit board comprises a ceramic circuit board, the arrangement being such that heat generated in use by the light source and control circuitry is transferred by conduction through the circuit board to the rear side of the circuit board and into the heat sink.

Preferably the ceramic circuit board comprises a ceramic substrate having a nano particle coating. Such ceramics are found to have advantageous heat transfer properties for efficiently transferring heat generated by the light source and associated circuitry through the ceramic and away from the front side of the ceramic.

Preferably the casing is manufactured from a conducting material, preferably steel. This has as an advantage that a further conduction route to the heat sink is provided.

Preferably, the lens arrangement comprises a lens and a lens holder.

Preferably a periphery of the ceramic circuit board is secured to the casing.

Preferably, a washer of thermally insulating or fireproof material is located between the casing and the ceramic circuit board. Preferably, the lens holder is secured to the casing. Preferably, a bezel supporting a glass is disposed forwardly of the lens, the bezel being located by the casing. Preferably, the bezel is fitted to the casing

Preferably the lighting unit further comprises a transformer and associated wiring.

### BRIEF DESCRIPTION OF THE DRAWINGS

The invention will now be described, by way of example only, in relation to the attached Figures, in which

FIG. 1 shows a side view of a lighting unit illustrating an embodiment of the present invention; and

FIG. 2 shows an end section of the lighting unit of FIG. 1;

FIG. 3 shows a side view of a second lighting unit illustrating a further embodiment of the present invention;

FIG. 4 shows an end section of the lighting unit of FIG. 3.

### DESCRIPTION OF PREFERRED EMBODIMENTS

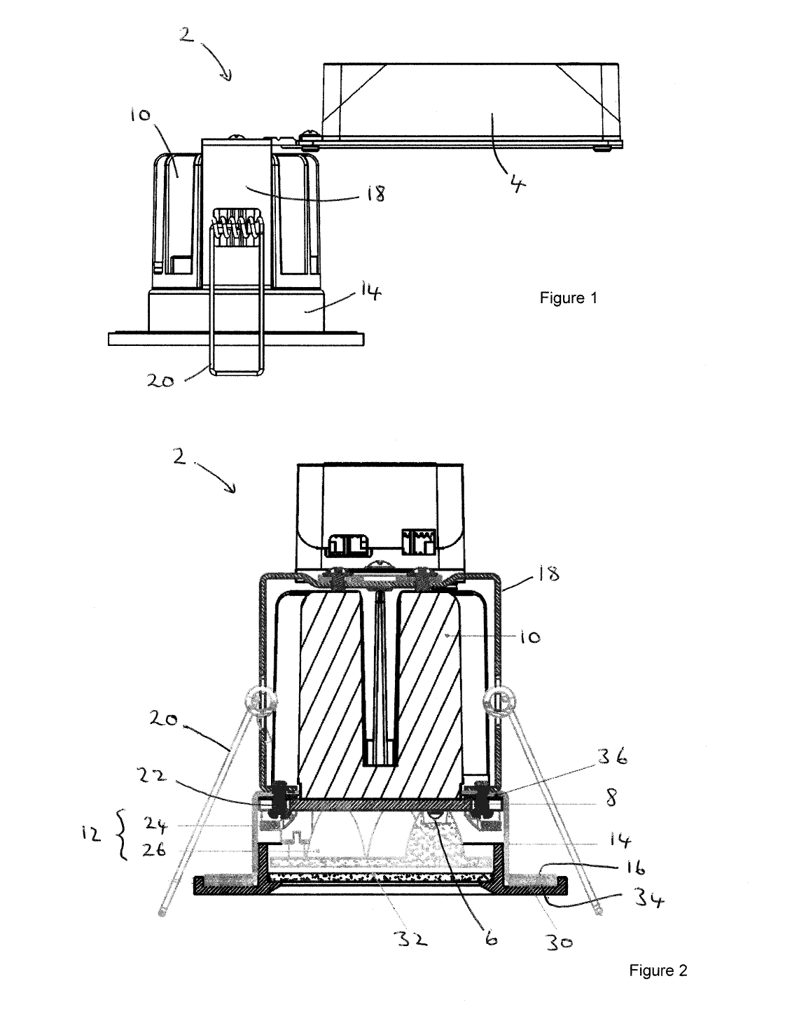

Referring first to FIGS. 1 and 2 there is shown a lighting unit is the form of a downlight unit 2 incorporating a terminal block, transformer unit or driver 4 provided on a mounting arm secured at one end to an upper end of the downlight unit 2.

The downlight unit comprises a light source 6 mounted to a circuit board 8, for example a printed circuit board, the circuit board including control circuitry for the light source 6, a heat sink 10 connected to a cylindrical casing, the heat sink 10 being provided to a rear side of the circuit board 8 and a lens arrangement 12 located at a front side of the circuit board.

The term “cylindrical casing” means conforming approximately to the shape of a hollow cylinder. It will be understood that a misshapen cylinder will work equally well. Similarly, while the embodiments show a generally circular cylindrical tubular body other sections may be used with amendment to the sectional shape of other components.

The light source preferably comprises one or more LEDs.

The heat sink 10 is formed from any suitable material, preferably cast aluminium. The heat sink 10 comprises at a lower end an outer annular portion for location against an upper portion of the cylindrical casing. The annular portion surrounds an end face. In the illustrated embodiment the end face is proud of the annular portion.

The cylindrical casing comprises a mounting ring 14. The mounting ring 14 comprises a side wall having a lower peripheral annular flange extending outwardly from a bottom end of the side wall and an upper peripheral annular flange extending inwardly from an upper end of the side wall. The mounting ring 14 is formed from any suitable material, preferably steel.

The upper peripheral flange locates against the annular portion of the heat sink and surrounds the end face of the heat sink.

A first ring or washer 16 of silicon is provided on the upper surface of the lower peripheral flange. In use, the ring or washer 16 butts up against a rim of an aperture into which the downlight is fitted.

A bracket 18 incorporating spring biased members or clips 20 is located about the heat sink 10. The spring biased members or clips 20 are adapted to secure the lighting unit in a recess in a known manner. It can be seen that the driver 4 is secured a central upper region of the bracket 18. The bracket 18 is secured to the upper peripheral flange of the mounting ring 14 in a suitable fashion, for example by screw fasteners 22.

The lens arrangement 12 comprises a lens holder 24 and a lens 26. The lens holder 26 may be of any suitable material, for example a polycarbonate. The lens may be of any suitable material, for example polymethylmethacrylate. The lens 26 is retained in position relative to the light source 6 by the lens holder 24. The lens holder 24 comprises a ring or washer having a support structure for engaging and securing the lens 26 to the lens holder 24, as well as an inwardly directed finger or fingers 28. The lens holder 24 is secured at its periphery to the upper peripheral flange of the mounting ring 14 in a suitable fashion, for example by utilising the screw fasteners 22 securing the bracket 18 to the mounting ring 14.

A bezel 30 is fitted to an underside of the mounting ring 14. The bezel 30 may be of any suitable material, for example cast aluminium. The bezel 30 comprises an inner wall having an inwardly directed shoulder toward a lower end and a radially outwardly directed annular flange at the lower end. The inner wall extends within the side wall of the mounting ring 14. In use the inner wall of the bezel and the side wall of the mounting ring are provided with cooperating features, such as male and female parts of a bayonet fixing, to enable the bezel 30 to be secured to the mounting ring 14. In use the inner shoulder supports a glass 32 located in front of the lens 26. The glass 32 is of any suitable material to allow transmission of the light emitted from the lens 26.

Preferably a second ring or washer 34 of silicon extends between the radially outwardly directed annular flange of the bezel 30 and the first peripheral flange of the mounting ring 14.

The circuit board 8 is generally circular and provided with fixtures, such as portions recessed from the circular periphery by which the circuit board may be located in position. For example the periphery of the circuit board to either side of the recessed portions serves to locate the circuit board with respect to the fasteners 22. In practice the circuit board 8 is secured between the heat sink 10 and the lens holder 24. The end face of the heat sink 10 is in thermal contact with a rear face of the circuit board. A ring or washer 36 of a suitable fireproof material is located between the edge of the circuit board 8 and the upper peripheral flange of the mounting ring 14.

The circuit board 8 is formed from a ceramic material having heat dissipation characteristics such that heat generated by the light source 6 at the front side of the circuit board 8 is readily transferred to the rear side of the circuit board 8 and then by conduction into the heat sink 10, such that heat is transferred by conduction directly from the circuit board 8 to the heat sink 10. Ceramic material having suitable characteristics includes that marketed by Jing De Zhen Fared Technology Co as part of their radiative heat dissipation technology.

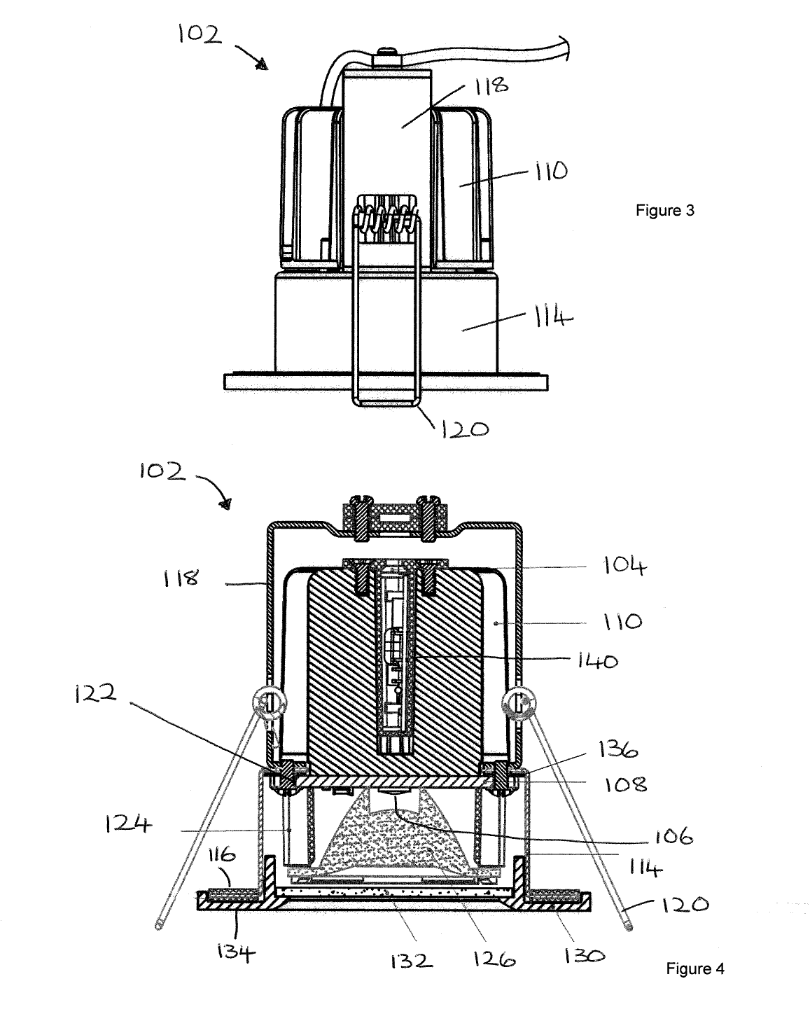

FIGS. 3 and 4 illustrate a downlight unit incorporating a different driver arrangement. Like parts have like reference numerals and similar parts will not be described in further detail.

The downlight unit 102 comprises a light source 106 mounted to a circuit board 108, the circuit board including control circuitry for the light source 106, a heat sink 110 provided to a rear side of the circuit board 108 and a lens arrangement located at a front side of the circuit board. The mounting ring 114 is of like configuration to that of the previous embodiment.

A bracket 118 having depending legs and a central portion is provided in which spring biased members or clips 120 are mounted on each of the legs. Feet at the free ends of the legs are secured to the mounting ring 114.

A driver 104 is mounted within a driver box 140 located within a recess in the heat sink 110. The associated wiring of the driver unit shown in FIG. 3 has been omitted from FIG. 4 for reasons of clarity. The driver box 140 is provided with flanges by which the driver box 140 may be secured to an upper part of the heat sink 110 by any suitable means.

The heat sink 110 is mounted on the mounting ring 114 with a front face of the heat sink 110 being located within an upper annular flange of the mounting ring 114.

A first ring or washer 116 of silicon is provided on a lower peripheral flange of the mounting ring 114.

The circuit board 108 is secured to the mounting ring 114 by fasteners 122, such that the end face of the heat sink 110 is in thermal contact with a rear surface of the circuit board 108. The fasteners 122 also serve to secure a lens holder 124 in position. The lens holder 124 is used to locate a lens 126 in position. A glass 132 retained by a bezel 132, itself located within and by the mounting ring 114, is disposed in front of the lens 126 and lens holder 124. A second ring or washer 134 of silicon extends between the bezel 130 and the mounting ring 114. A ring or washer 136 of fireproof material is located between the circuit board 108 and the mounting ring 124.

In this embodiment also, heat generated by the light source 106 and associated circuitry at the front side of the circuit board 108 is readily transferred to the rear side of the circuit board 108 and then to a front face of the heat sink 110, such that heat is transferred by conduction directly from the circuit board 108 to the heat sink 110.

1. lighting unit for mounting in an aperture comprises a casing and a heat sink mounted to one side of the casing, a light source mounted on a front side of a circuit board, the circuit board including control circuitry for the light source, the heat sink provided in thermal contact with a rear side of the circuit board and a lens arrangement located to the front side of the circuit board, the circuit board and the light source being located in the casing, wherein the circuit board comprises a ceramic circuit board, the arrangement being such that heat generated in use by the light source and control circuitry is transferred by conduction through the circuit board to the rear side of the circuit board and into the heat sink.

2. The lighting unit according to claim 1 in which the ceramic circuit board comprises a ceramic substrate having a nano particle coating.

3. The lighting unit according to claim 1, in which the lens arrangement comprises a lens and a lens holder.

4. The lighting unit according to claim 1, wherein a periphery of the ceramic circuit board is secured to the casing.

5. The lighting unit according to claim 1, wherein a thermal insulating layer is located between the casing and the ceramic circuit board.

6. lighting unit according to claim 3, wherein the lens holder is secured to the mounting ring.

7. The lighting unit according to claim 3, wherein a bezel supporting a glass is disposed forwardly of the lens, the bezel being located by the mounting ring.

8. The lighting unit according to claim 7, wherein the bezel is fitted to the casing.

9. The lighting unit according to claim 1, wherein the lighting unit further comprises a transformer and associated wiring.

10. (canceled)
